(19) United States
(12) Patent Application Publication
(10) Pub. No.: US 2023/0264784 A1
(43) Pub. Date: Aug. 24, 2023

(54) FLOATING SUPPORT STRUCTURE FOR OFFSHORE WINDMILL

(71) Applicant: CEFRONT TECHNOLOGY AS, Arendal (NO)

(72) Inventors: Kåre Syvertsen, Tveit (NO); Ragnar Thunes, Færvik (NO); Jan Vidar Aarsnes, Høvåg (NO)

(73) Assignee: Ocean Ventus AS, Grimstad (NO)

(21) Appl. No.: 18/010,354

(22) PCT Filed: Jun. 15, 2021
(86) PCT No.: PCT/EP2021/066031

§ 371 Date: Dec. 14, 2022

(30) Foreign Application Priority Data
Jun. 19, 2020 (NO) 20200726

(51) Int. Cl. B63B 1/08; F03D 13/25; B63B 39/02; B63B 21/20

(52) U.S. Cl. CPC B63B 1/08; F03D 13/25; B63B 39/02; B63B 21/20; B63B 2035/446

(57) ABSTRACT

A floating support structure for supporting a windmill system includes a windmill tower, a windmill nacelle, and windmill blades. The support structure includes an aft main section, a transverse main section, and a connecting flange. The aft main section includes a horizontal aft part with a first horizontal aft end and a second horizontal aft end, a vertical aft part with a first vertical aft end at least indirectly connected perpendicular to the first horizontal aft end and a second vertical aft end, and an aft damping structure connected to the second vertical aft end. The vertical and the horizontal aft parts are oriented in a common vertical aft plane. A horizontal cross sectional area of the aft damping structure is larger than a horizontal cross-sectional area of the second vertical aft end. The transverse main section includes a horizontal transverse part with a first horizontal transverse end and a second horizontal transverse end, two vertical transverse parts, each having a first vertical transverse end and a second vertical transverse end, wherein the first vertical transverse ends of the vertical transverse parts are at least indirectly connected perpendicular to the first and second horizontal transverse ends, and two transverse damping structures connected to the second vertical transverse ends of the respective two vertical transverse parts. The two vertical transverse parts and the horizontal transverse part are oriented in a common vertical transverse plane. A horizontal cross sectional area of each of the transverse damping structures is larger than a horizontal cross sectional area of the second vertical transverse end. The connecting flange is for connecting a coupling end of the windmill tower distal to the windmill nacelle vertically onto the floating support structure. The second horizontal aft end of the aft main section is connected to the horizontal transverse part of the transverse main section such that the vertical aft plane is oriented perpendicular to the vertical transverse plane.

### TECHNICAL FIELD

The present invention relates primarily to a floating, preferably semi-submersible, support structure for offshore windmills.

The support structure is particularly suitable for transport as modules on heavy-lift vessels over large distances and assembly of these modules in sea.

### BACKGROUND AND PRIOR ART

Floating support structures for offshore windmills are known in the art.

For example, patent publication US 2014/0196654 A1 discloses a floating support structure for windmills consisting of columns having stabilizing elements mounted to their ends. The columns have an inner volume for ballasting. Another type of support structure having the possibility of stabilization and ballasting is disclosed in patent publication US 2019/0061884 A1. Yet other examples of floating support structures are disclosed in patent publications U.S. Pat. No. 10,518,846 B2, WO 2014/163501 A1 and JP 2005-201194 A.

A common disadvantage for any of the known floating support structures of the above-mentioned type is that they are ill-suited for transport across large distances on vessels due to their bulky design and heavy weight.

In view of the above, it is an object of the invention to provide a floating support structure that solves or at least mitigates one or more of the aforementioned problems related to use of prior art solutions.

A particular object of the invention is to provide a floating support structure that may easily be produced in parts or modules, thereby facilitating long distance transport on suitable vessels such as semi-submersible vessels.

Another object of the invention is to provide parts or modules that may be assembled into a fully functional floating support structure of the above-mentioned type when submerged/floating in water.

Yet another object of the invention is to provide a floating support structure that may easily be towed from an assembly site to an operation site using a tugboat.

Yet another object of the invention is to provide a floating support structure that ensures sufficient robustness with respect of transfer of torque, torsion and shear forces during operation.

Yet another object of the invention is to provide a floating support structure that ensures favorable motion characteristics during operation, even in rough seas.

### SUMMARY OF THE INVENTION

The present invention is set forth and characterized in the independent claims, while the dependent claims describe other characteristics of the invention.

In one aspect, the invention concerns a floating support structure suitable for supporting a windmill system comprising a windmill tower, a windmill nacelle and windmill blades.

The support structure comprises an aft main section comprising a horizontal aft part with a first horizontal aft end and a second horizontal aft end, a vertical aft part with a first vertical aft end at least indirectly connected perpendicular to the first horizontal aft end and a second vertical aft end, wherein the vertical and the horizontal aft parts are oriented in a common vertical aft plane, and an aft damping structure connected to the second vertical aft end. A horizontal cross-sectional area of the aft damping structure is larger than a horizontal cross-sectional area of the second vertical aft end.

The support structure further comprises a transverse main section comprising a horizontal transverse part with a first horizontal transverse end and a second horizontal transverse end, two vertical transverse parts, each having a first vertical transverse end and a second vertical transverse end, wherein the first vertical transverse ends of the vertical transverse parts are at least indirectly connected perpendicular to the first and second horizontal transverse ends, wherein the two vertical transverse parts and the horizontal transverse part are oriented in a common vertical transverse plane and two transverse damping structures connected to the second vertical transverse ends of the respective two vertical transverse parts. As for the damping structure of the aft main section, a horizontal cross-sectional area of each of the transverse damping structures is larger than a horizontal cross-sectional area of the second vertical transverse end.

The support structure further comprises a connecting flange for connecting a coupling end of the windmill tower distal to the windmill nacelle and vertically onto the floating support structure.

The second horizontal aft end of the aft main section is connected to the horizontal transverse part of the transverse main section such that the vertical aft plane is oriented perpendicular to the vertical transverse plane.

Horizontal is herein defined as the orientation perpendicular to the vertical aft part, the vertical transvers parts and perpendicular to the vertical aft and transverse planes.

In an exemplary configuration, the connecting flange is arranged on the horizontal aft part, for example at, or near, the support structure's center of buoyancy. The connecting flange has preferably a tubular shape with an inside diameter being equal or larger than an outside diameter of the coupling end of the windmill tower.

In another exemplary configuration, the horizontal aft part encloses at least one hollow volume situated adjacent to the connecting flange, wherein at least one reinforcement structure is arranged within the at least one hollow volume. An example of a reinforcement structure may be plates with suitable rigidity/strength orientated vertically and/or horizontally and fixed to the internal wall(s) representing the outer boundary of the volume(s).

In yet another exemplary configuration, each of the horizontal aft part, the vertical aft part, the horizontal transverse part and the vertical transverse parts encloses at least one hollow volume. The percentage of this or these hollow volume(s) may be 50% or more of the total volume of the respective part, more preferably 70% or more, for example 90%. If for example each part is a tube, the difference between the total volume and the hollow volume is the volume of the tube walls.

In yet another exemplary configuration, at least a section of the at least one hollow volume within the vertical aft parts and the vertical transverse parts, hereinafter called the ballast section, is filled (or may be filled) with a ballast substance, for example a liquid such as seawater, allowing regulation of the draft of the floating support structure prior to submersion, and/or during submersion, and/or after submersion, into water. Hence, the buoyancy section constitutes at least part of a draft regulator system.

In yet another exemplary configuration, the second horizontal aft end is connected at a longitudinal mid position, or near a longitudinal mid position, of the horizontal transverse part, thereby achieving a desired high symmetry of the support structure.

In yet another exemplary configuration, the second horizontal aft end of the aft main section is connected to the horizontal transverse part via a coupling structure.

In yet another exemplary configuration, the coupling structure encloses at least one hollow volume, wherein at least one reinforcement structure is arranged within this or these hollow volume(s). As described above, an example of a reinforcement structure may be plates with suitable rigidity/strength orientated vertically and/or horizontally and fixed to the internal wall(s) representing the outer boundary of the volume(s).

In yet another exemplary configuration, the aft main section further comprises a bent aft part connecting the second horizontal aft end of the horizontal aft part to the first vertical aft end of the vertical aft part. Further, the transverse main section may comprise two bent transverse parts connecting the first and second horizontal transverse ends of the horizontal transverse part with the respective first vertical transverse ends of the two vertical transverse parts. The bent aft part may in this configuration extend from the horizontal aft part at an aft angle α_{A} relative to the horizontal plane. Similarly, the two bent transverse parts may each extend from the first horizontal transverse end and the second horizontal transverse end, respectively, at a transverse angle α_{T} relative to the horizontal plane. Both the aft angle α_{A} and the transverse angle α_{T} have non-zero values and preferably equal or near equal.

In yet another exemplary configuration, the bent aft part is shaped as a frustum such as a cut cone, having its smallest cross-sectional area connected to the second horizontal aft end. Moreover, each of the two bent transverse parts is shaped as frustum having its smallest cross-section area connected to the respective first and second horizontal transverse ends.

In yet another exemplary configuration, each of the bent aft part and the two bent transverse parts encloses at least one hollow volume. The enclosed volume(s) may be 50% or more of the total volume for each part more preferably 70% or more, for example 90%. Further, at least a section of the at least one hollow volume within the bent aft part and the two bent transverse parts, hereinafter called the buoyancy section(s), is configured to be filled with, or depleted of, a buoyancy substance such as gas or liquid, allowing regulation of the buoyancy of the floating support structure when submerged in water. Hence, the buoyancy section(s) constitutes in this configuration another part of the above-mentioned draft regulator system. The gas and liquid may for example be air and seawater, respectively.

In yet another exemplary configuration, each of the horizontal aft part, the vertical aft part, the horizontal transverse part and the vertical transverse parts has a tubular shape such as a straight tube or a set of straight tubes fixed parallel to each other. In the latter case, each tube may be cut along their longitudinal direction and then joined at the cut surfaces in order to create a continuous hollow interior volume.

In yet another exemplary configuration, the floating support structure further comprises a mooring assembly comprising an aft mooring line connected to the aft main section, a first transverse mooring line connected to an end part of the transverse main section along the vertical transverse plane and a second transverse mooring line connected to the opposite end part of the transverse main section along the vertical transverse plane. Preferred locations of the ends of the mooring lines on the support structure are on the bent aft part (for the aft mooring line) and the two bent transverse parts (for the first and second transverse mooring lines) and/or at or near the connection area of the bent parts and the horizontal parts.

In a second aspect, the invention concerns a windmill facility comprising a floating support structure in accordance with the support structure described above, a windmill tower having a low end fixed to the connecting flange, a windmill nacelle fixed at a top end of the windmill tower and windmill blades rotationally coupled to the windmill nacelle. The rotational coupling may be achieved by equipping the windmill nacelle with a suitable rotational device such as a motorized swivel.

Typically, the shipyard building the aft main section and the transverse main section and the assembly site are situated at locations where towing to the location for assembly is not a suitable option. Hence, the sections should be transported on deck of vessels such as semi-submersible heavy-lift vessels. The operation of arranging the sections on the deck at the production site, and subsequent off-loading and assembly at the assembly site, is described in detail below.

Note that use of semi-submersible vessels to place the sections above the deck represents just one of several methods. An example of an alternative method may be the use of skids that allows the sections to slide from the quay onto the deck.

In a third aspect, the invention concerns a method for assembling one or more floating support structure(s) at an assembly site using a plurality of floating sections produced at a production site distal from the assembly site. An example of a production site and an assembly site may be China and Norway, respectively.

Each of the plurality of sections comprises a horizontal part and a vertical part which are connected at least indirectly to the horizontal part.

The method comprises the following steps:
A. connecting at the production site the plurality of sections to each other, preferably side-by-side, by use of a locking structure, thereby forming a stable floating transport assembly,
B. launching the transport assembly into water such that the horizontal parts are arranged below the vertical parts relative to the water surface,
C. arranging the transport assembly onto a transport vessel such that the horizontal parts are being supported on a deck of the transport vessel,
D. moving the transport vessel with the transport assembly to the assembly site,
E. launching the transport assembly into water from the transport vessel, again such that the horizontal parts are arranged below the vertical parts relative to the water surface,
F. adjusting the freeboard of the transport assembly by use of a draft regulator system to a predetermined intermediate freeboard F_{I},
G. disconnecting the locking structure, thereby detaching the sections from each other, preferably one by one,
H. turning each section by adjusting the freeboard of each section to a predetermined low freeboard F_{L}, being lower than the intermediate freeboard F_{I}, by use of the draft regulator system,
I. pulling together and interconnecting at least two of the plurality of floating sections to form the floating support structure.

The term “side-by-side” is herein defined as when the elongated sides of the horizontal parts are arranged in parallel.

An example of a low freeboard F_{L} may for example be about 2 to 3 meters of the typical height of the main sections

In an exemplary performance of the method, step C further comprises the following step:

arranging the transport assembly onto the transport vessel where the transport assembly is kept at a predetermined high freeboard F_{H}, being higher than the intermediate freeboard F_{I}, by use of the draft regulator system.

When launching for transferring the assembly to a transport vessel all internal sections of the main section may be kept dry, i.e. no water-filling. An example of a high freeboard F_{H} may for example be about 20 to 25 meters of the typical height of main sections.

In another exemplary performance of the method, the transport vessel is a semi-submersible vessel and step C further comprises the following steps:
ballasting ballast tanks of the vessel in order to increase the vessel's draft, preferably to a level where the transport assembly may be moved/towed to a position above the deck without requiring lifting,
arranging/moving/towing the transport assembly on or above the deck of the vessel, for example by use of a tug-boat and/or a crane and
de-ballasting the ballast tanks of the vessel to decrease the vessel's draft such that the transport assembly is resting on the vessel's deck.

In yet another exemplary performance of the method, step E further comprises the following steps:
ballasting ballast tanks of the semi-submersible vessel in order to increase the vessel's draft, preferably such that the transport assembly is floating or near floating in the sea above the deck, and
arranging/moving/towing the transport assembly horizontally to a location away from (clear of) the horizontal extend of the vessel's deck.

Note that the term ‘horizontal’ means throughout the description parallel to the water surface at rest.

In yet another exemplary performance, the method further comprises the following step performed between step G and H:
adjusting the freeboard of each section to a lower intermediate freeboard F_{IL}, being lower than the intermediate freeboard F_{I}, by use of the draft regulator system, in order to achieve high stability during and/or after release of the sections from the transport assembly.

An example of an intermediate freeboard F_{I} may for example be about 3 to 5 meters of the typical height of the main sections.

In yet another exemplary performance of the method, each of the plurality of sections comprises a buoyancy tank arranged at positions vertically offset from the position of the one or more internal ballast tanks, and preferably higher with reference to the water surface, wherein the buoyancy tanks are permanently closed passive air-filled tanks.

In another exemplary performance of the method, the buoyancy tanks comprise a closable opening for filling or discharging the buoyancy tanks for buoyancy substance.

For this exemplary performance of the method, step H may further comprise the step of adjusting the amount of buoyancy substance in the buoyancy tank prior to, or during, the turning of each section such that stability is ensured stability during execution of step H.

In yet another exemplary performance, the method further comprises the following step:
J. adjusting the freeboard of the floating support structure to a predetermined operational freeboard F_{O} being higher than the low freeboard F_{L} by use of by use of the draft regulator system, wherein the operational freeboard F_{O} is such that the horizontal parts of each section are above the water surface for allowing permanent coupling of the sections.

Alternatively to step J, step I may further comprise the following steps:

a) adjusting the freeboard of the at least two sections to be interconnected by use of the draft regulator system, for vertical alignment of the at least two horizontal parts,

b) temporary interconnecting the at least two sections in final horizontal orientations by use of a first coupling device,

c) optionally adjusting the freeboard of the interconnected at least two sections by use of the draft regulator system to a predetermined operational freeboard F_{O} being higher than the low freeboard F_{L}, preferably such that the horizontal parts are at least partly, preferably fully, above the water surface, and

d) permanently interconnecting the at least two sections by use of a second coupling device such as welding the two parts together directly or via a coupling structure.

Step I a) and step I b) may alternatively be interchanged.

The first coupling device may for example be guide plates fixed on top of both horizontal parts to ensure correct positioning of the two sections. When the sections are in place, the guide plates may be welded together.

For step I c) the operational freeboard F_{O} may be set equal to the intermediate freeboard F_{I}.

The main aft section comprises a horizontal aft part with a first horizontal aft end and a second horizontal aft end and a vertical aft part with a first vertical aft end at least indirectly connected perpendicular to the first horizontal aft end and a second vertical aft end, wherein the vertical and the horizontal aft parts are oriented in a common vertical aft plane.

Further, the main transverse section comprises a horizontal transverse part with a first horizontal transverse end and a second horizontal transverse end and two vertical transverse parts, each having a first vertical transverse end and a second vertical transverse end. The first vertical transverse ends of the vertical transverse parts are at least indirectly connected perpendicular to the first and second horizontal transverse ends. The two vertical transverse parts and the horizontal transverse part are oriented in a common vertical transverse plane.

A connecting flange is arranged on either the horizontal aft part, the horizontal transverse part or a coupling structure connecting the horizontal aft part and the horizontal transverse part, more preferably on top of the horizontal aft part at or near the gravitational center point of the assembled floating support structure. The connecting flange is configured to connect to a coupling end of a vertically oriented windmill tower. Hence, it has preferably a tubular shape with an inside diameter being equal or larger that an outside diameter of the coupling end of the windmill tower.

Said mooring lines may comprise an aft mooring line connected to the aft main section, a first transverse mooring line connected to an end part of the transverse main section along the vertical transverse plane and a second transverse mooring line connected to the opposite end part of the transverse main section along the vertical transverse plane.

In yet another exemplary performance, the method further comprises the following step:
K. arranging vertically an end of a windmill tower to the connecting flange of the floating support structure by use of a crane on a vessel.

The windmill tower may constitute part of a windmill system comprising the windmill tower, a windmill nacelle connected to the other end of the windmill tower and windmill blades rotationally connected to the windmill nacelle.

In yet another exemplary performance, the method further comprises the following steps:
L. towing the floating support structure from the assembly site to an installation site and
M. mooring the floating support structure to the seabed by use of a mooring system installed on the plurality of sections and mooring lines connected to the mooring system.

In yet another exemplary performance of the method, the aft main section further comprises an aft damping structure connected to the second vertical aft end, wherein a horizontal cross-sectional area of the aft damping structure is larger than a horizontal cross-sectional area of the second vertical aft end. Furthermore, the transverse main section may comprise two transverse damping structures connected to the second vertical transverse ends of the respective two vertical transverse parts, wherein a horizontal cross-sectional area of each of the transverse damping structures is larger than a horizontal cross-sectional area of the second vertical transverse end, and preferably of equal horizontal cross-sectional area as the aft damping structure.

In yet another exemplary performance of the method, each of the horizontal aft part, the vertical aft part, the horizontal transverse part and the vertical transverse parts encloses at least one hollow volume.

In yet another exemplary performance of the method, the second horizontal aft end is at step I connected at a longitudinal mid position, or near a longitudinal mid position, of the horizontal transverse part.

In yet another exemplary performance of the method, the aft main section further comprises a bent aft part connecting the second horizontal aft end of the horizontal aft part to the first vertical aft end of the vertical aft part. Further, the transverse main section may comprise two bent transverse parts connecting the first and second horizontal transverse ends of the horizontal transverse part with the respective first vertical transverse end of the two vertical transverse parts.

In yet another exemplary performance of the method, each of the plurality of sections has a tubular shape.

### BRIEF DESCRIPTION OF THE DRAWINGS

The following drawings are appended to facilitate the understanding of the invention. The drawings show embodiments of the invention, which will now be described by way of example only.

FIG. 1 shows a fully assembled floating windmill facility according to the invention, seen from the side (FIG. 1A) and from above (FIG. 1B).

FIG. 2 shows in perspective a support structure for a floating windmill facility according to a first embodiment of the invention, where the inner reinforcement structure within the encircled part of the support structure is detailed in the lower drawing.

FIG. 3 shows main sections constituting the support structure of FIG. 2 in different angles, wherein FIG. 3A depicts the transverse main section seen along the longitudinal direction (upper left), seen along the transverse direction (upper right) and seen from above (lower left) and FIG. 3B depicts the aft (or longitudinal) main section seen along the longitudinal direction (upper left), seen along the transverse direction (upper right) and seen from above (lower left).

FIG. 4 shows cross-sections of the transverse main section and the aft main section of FIGS. 2 and 3 seen along the longitudinal direction and along the transverse direction, respectively.

FIG. 5 shows in perspective a support structure for a floating windmill facility according to a second embodiment of the invention, where the inner reinforcement structure within the encircled part of the support structure is detailed in the lower drawing.

FIG. 6 shows cross-sections of the support structure of FIG. 5, wherein FIG. 6A, FIG. 6B and FIG. 6C depict the cross-sections of the support structure seen from above, seen along the transverse direction and seen along the longitudinal direction, respectively.

FIG. 7 shows three transverse main sections and three aft main sections bundled up in a transport assembly and floating in sea, wherein FIG. 7A and FIG. 7B depict the transport assembly seen from above and from the side, respectively.

FIG. 8 shows side views of steps for arranging the transport assembly of FIG. 7 onto a deck of a transport vessel, wherein FIG. 8A, FIG. 8B and FIG. 8C depict the transport assembly floating in water distant from the vessel, positioned above the deck when the vessel is submersed and supported onto the deck when the vessel is seaworthy, respectively.

FIG. 9 shows in perspective a transport vessel supporting a transport assembly of three transverse main sections and three aft main sections on deck.

FIG. 10 shows side views of steps for launching the transport assembly of FIG. 9 into the sea from the deck of the transport vessel, wherein FIG. 10A, FIG. 10B and FIG. 10C depict the transport assembly supported onto the deck when the vessel is seaworthy, positioned above the deck when the vessel is submerged and floating in sea distant from the vessel, respectively.

FIG. 11 shows side views of the step of turning each section of the transport assembly of FIG. 9 to installation positions, wherein FIG. 11A depicts the bundled transport assembly at intermediate freeboard and FIGS. 11B and 11C depict the aft main section at low freeboard in an upside-down position and in an installation position, respectively.

FIG. 12 shows side views of the step for turning each sections of the transport assembly to installation positions, wherein FIG. 12A depicts the transverse main section at intermediate freeboard and FIGS. 12B and 12C depict the transverse main section at low freeboard in an upside-down position and in installation position, respectively.

FIG. 13 shows side views of an assembled support structure in accordance with the first embodiment of the invention, wherein FIG. 13A and FIG. 13B depict the support structure in a low freeboard F_{L} and a high, operational freeboard F_{O}.

FIG. 14 shows a top view of a fully assembled windmill facility moored to the seabed.

FIG. 15 shows side views of a part of the transverse main section onto which a mooring system is fixed, the mooring system comprising a static fastening device with a mooring line attached thereto, wherein FIG. 15A and FIG. 15B depict the transverse main section seen along the longitudinal direction and along the transverse direction, respectively, and where detailed drawings of the static fastening device are shown encircled.

FIG. 16 shows a side view of a part of the aft main section onto which a mooring system is fixed, the mooring system comprising a dynamic fastening device with a mooring chain attached thereto, and where a detailed drawing of the dynamic fastening device is shown encircled.

FIG. 17 shows a side view of a part of the aft main section onto which a winch system is installed on top of the horizontal pipe for winching electric cables.

FIG. 18 shows a flowchart of the steps to produce, transport and assemble a support structure.

FIG. 19 shows a flowchart of the steps to install a windmill facility after having completed the production, transport and launching in sea.

FIG. 20 shows a side view of the transverse main section and the aft main section, wherein FIG. 20A and FIG. 20B depict examples of the location of the external filling valves.

FIG. 21 shows a side view of the transverse main section and the aft main section, wherein FIG. 21A and FIG. 21B depict through openings in the first and second buoyancy tanks and further details.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

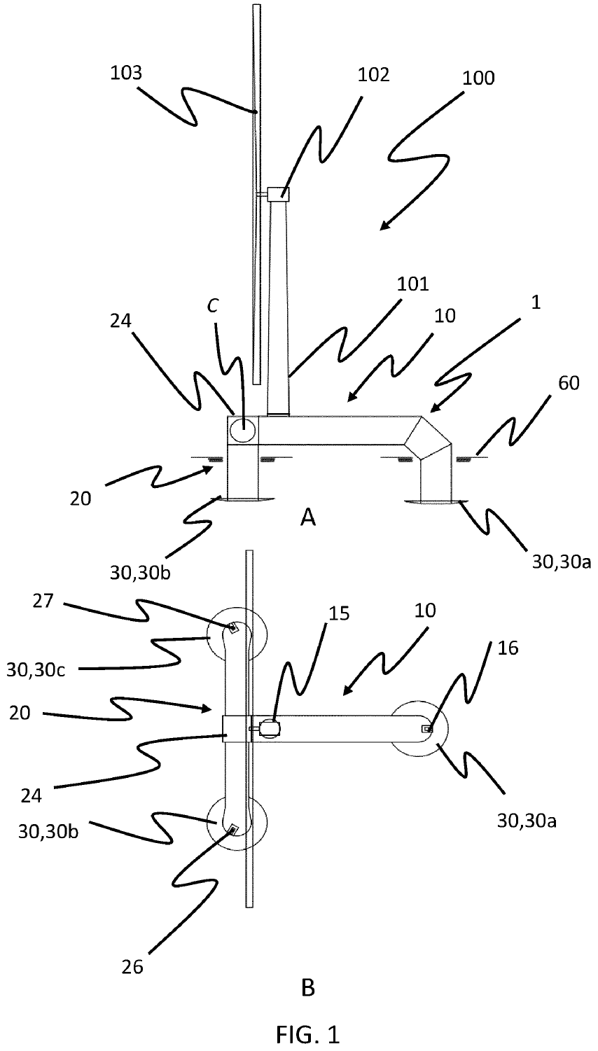

With particular reference to FIGS. 1-4, the windmill facility 100 as shown fully assembled in FIG. 1 includes a windmill tower 101, a windmill nacelle 102 mounted on the top end of the tower 101 and windmill blades 103 rotatably coupled to the windmill nacelle 102. The bottom end of the windmill tower 101 is fixed to a floating support structure 1 within a dedicated connection flange 15. The support structure 1 is configured to float in sea with a buoyancy that ensures a desired stability of the windmill facility 100.

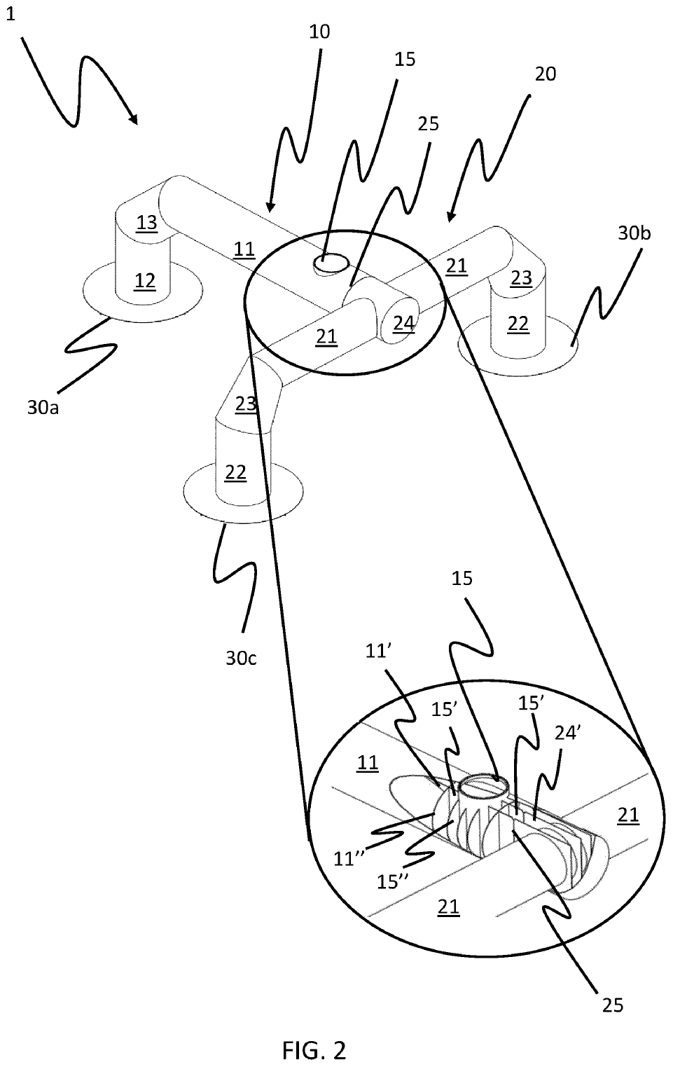

As best seen in FIG. 2, the support structure 1 comprises two main sections 10,20 interconnected by a coupling structure 24.

The first main section 10, hereinafter called the aft main section 10, comprises a horizontal pipe 11, a vertical pipe 12 and a transition cone 13 joining the horizontal and vertical pipes 11,12. The diameter of the pipes 11-13 should be made large enough to ensure the necessary structural strength to allow long time operation of the windmill facility 100, also in harsh weather conditions.

A damping structure 30 in form of a horizontal plate 30a is attached at the end of the vertical pipe 12 distal to the transition cone 13. The purpose of the damping structure 30 is to reduce/minimize movements of the support structure 1 due to waves and currents during offshore operation of the windmill facility 100.

The second main section 20, hereinafter called the transverse main section 20, comprises a horizontal pipe 21, two vertical pipes 22 and two transition cones 23 joining the vertical pipes 22 to each end of the horizontal pipe 21. The horizontal pipe 21 may be set up by several horizontal portions. In the particular configuration shown in FIG. 2, the horizontal pipe 21 includes two portions connected end by end distal to the transition cones 23 via the coupling structure 24 interconnecting the aft main section 10 and the transverse main section 20. As for the aft main section 10, a damping structure 30 in form of a horizontal plate 30b, c is attached at the end of each vertical pipes 22, i.e. the ends distal to the respective transition cones 23.

The general design of the damping structures 30, such as the horizontal cross-sectional area of the plates 30a-c relative to the cross-sectional area of the ends of the vertical pipes 12,22, can be determined by model testing and/or computer modelling.

The transfer of forces from the windmill tower 100 to the support structure 1 takes place through the connecting flange 15 which may be a bolted flange welded on top of a transfer pipe which again is welded in vertical direction to the horizontal pipe 11. The transfer pipe and the horizontal pipe 11 have preferably equal or almost equal diameters.

With particular reference to the encircled detailed drawing in FIG. 2, the connection flange 15 (adapted to receive the end of the windmill tower 101), the horizontal pipe 11 of the aft main section 10 and the coupling structure 24 contain reinforcement structures 11′,11″,15′,15″,24′ in form of vertical plates oriented in transverse direction 11″,15″ (i.e. along the direction of the horizontal tubes 21 of the transverse main section 20) and perpendicular to the transverse direction 11′,15′,24′ (hereinafter also called the longitudinal direction). Similar horizontal plates may also be envisaged.

The reinforcement plates with reference numerals 15′,15″ oriented along and perpendicular to the transverse direction are welded to the inside walls of the horizontal pipe 11 of the aft main section 10 and to the connecting flange 15. Further, the reinforcement plates in the longitudinal direction with reference numeral 24′ are welded to either the horizontal pipe 21 of the transverse main section 20 or the coupling structure 24 or both. And finally, the reinforcement plates with reference numerals 11′,11″ are welded to the inside wall of the horizontal pipe 11 of the aft main section 10 only.

The reinforcement plate 15″ fixed between the transfer pipe and the inner surface of the horizontal pipe 11 ensures that the horizontal pipe 11 maintains full structural strength throughout its length also in the parts where the load is high.

Moreover, due to the reinforcement plates 11′,11″,15′,15″,24′, the forces from the connecting flange 15 are transferred into the aft horizontal pipe 11 and the transverse horizontal pipe 21.

A joint 25 joining the aft main section 10 and the transvers main section 20 is in FIG. 2 shown positioned along the walls of the coupling structure 24 and the walls of the end of the horizontal pipe 11. Further, as illustrated in the lower drawing in FIG. 2, the longitudinally directed reinforcement plate 24′ within the coupling structure 24 may alternatively or additionally be fixed in a joint 25 to the longitudinally directed reinforcement plate 15′ fixed to the connecting flange 15. The joint 25 is typically made by welding. The parts of the aft main section 10 and parts of the coupling structure 24 constituting the joint 25 may be overlapping in the longitudinal direction to further increase the mechanical strength.

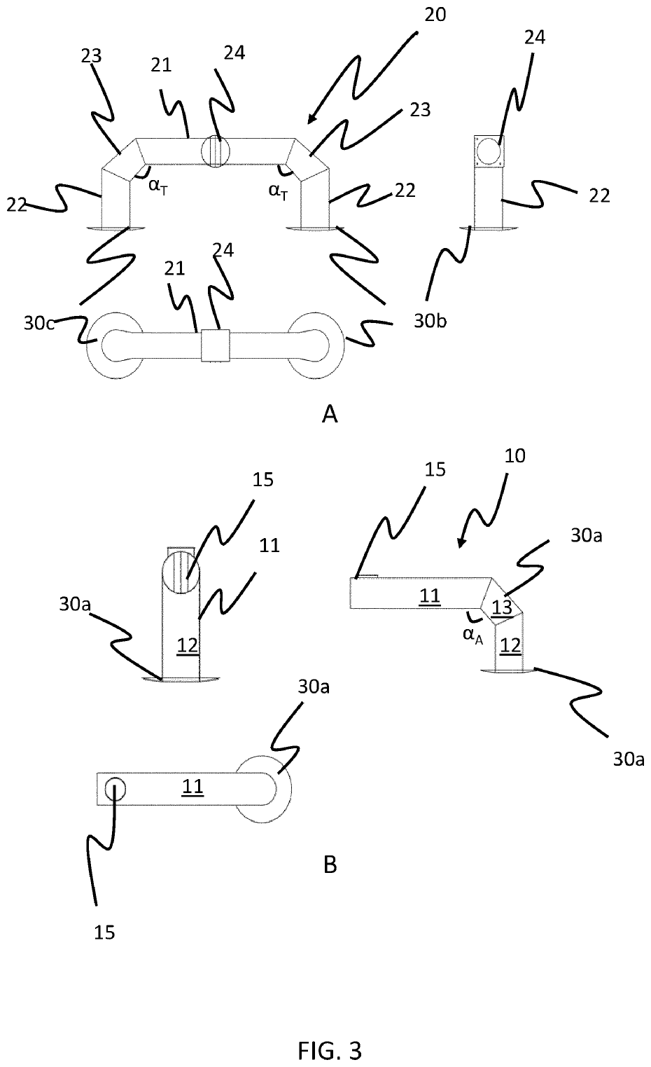

The two main sections 10,20 and the coupling structure 24 are illustrated in different angles in FIG. 3A (aft main section) and FIG. 3B (transverse main section). As explained in further detail below, these two main sections 10,20 and the coupling structure 24 are being produced separately in a shipyard prior to transport of the parts 10,20,24 by a transport vessel 200 to a harbor at or near the installation site of the windmill facility 100. Note that the coupling structure 24 is integrated with the transverse main section 20 at the shipyard. The transverse main section 20 and the coupling structure 24 may therefore be considered as one unit. Hereinafter in the description, reference to the main section 20 can be considered to also include the coupling structure 24.

The angle between the transverse horizontal pipe 21 and the transition cones 23 joining both ends with the transverse vertical pipes 22 is defined as α_{T}. Likewise, the angle between the aft horizontal pipe 11 and its transition cone 13 joining the end with the aft vertical pipe 12 is defined as α_{A}. In the configurations shown in all accompanied drawings, the angles α_{T}, α_{A} are equal and non-zero, typically between 30° and 60° relative to the horizontal plane.

The aft main section 10 comprises a hollow volume 18.

The transverse main section 20 comprises a hollow volume 28.

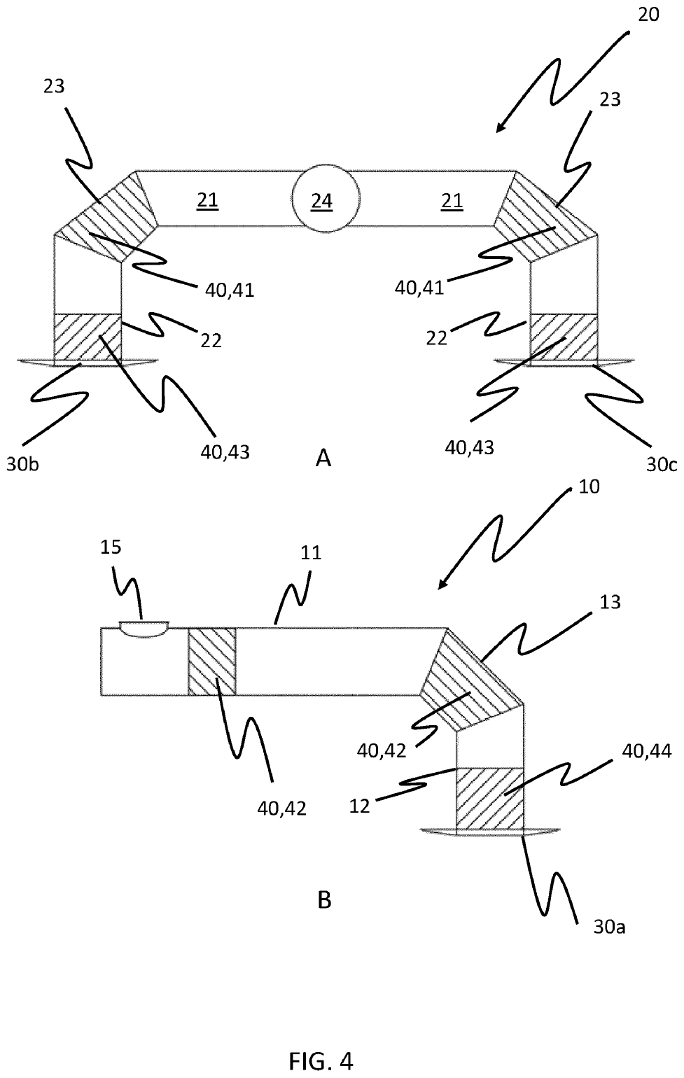

To ensure inter alia high stability during offshore operation of the windmill facility 100, the support structure 1 is equipped with ballast tanks 43,44. A specific example of a ballast tank arrangement is seen in FIG. 4, where enclosed ballast tanks 43,44 are provided at the lower end of each vertical pipe 12,22, thereby enabling filling and draining of ballast liquid in order to regulate the draft of the support structure 1 when submerged in water.

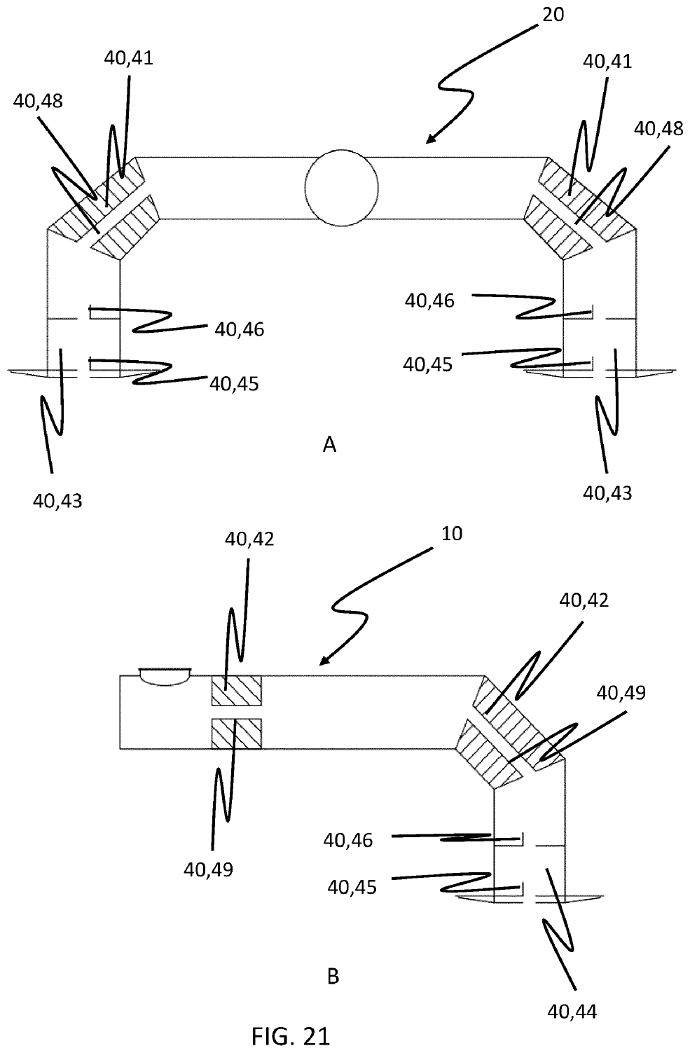

The ballast tanks 43,44 comprise opening valves 45 for filling and draining of ballast fluid as seen in FIG. 21A,B. The opening valves 45 are configured to alternate between an open position and a closed position. The open position allows flow of fluid or gas between the external environment of the support structure 1 and the ballast tanks 43,44. The closed position enables the ballast tanks 43,44 to be fully sealed and for example hold a predetermined amount of ballast fluid. The opening valves 45 thus provide a closable opening between the ballast tanks 43,44 and the external environment, for example the sea. The opening valves 45 are depicted in an open position.

The ballast tanks 43,44 further comprise internal filling valves 46 for filling and draining the hollow volumes 18,28 of the aft main section 10 and the transverse main section 20 respectively. The internal filling valves 46 are configured to alternate between an open position and a closed position. The open position allows flow of a fluid or gas between ballast tanks 43,44 and the hollow volumes 18,28 of the main sections 10,20. The closed position enables the hollow volume of the main sections 10,20 to be fully sealed and for example hold a predetermined amount of ballast fluid. The internal filling valves 46 thus provide a closable opening between the ballast tanks 43,44 and the hollow volumes 18,28 of the main sections 10,20. The internal filling valves 46 are depicted in an open position.

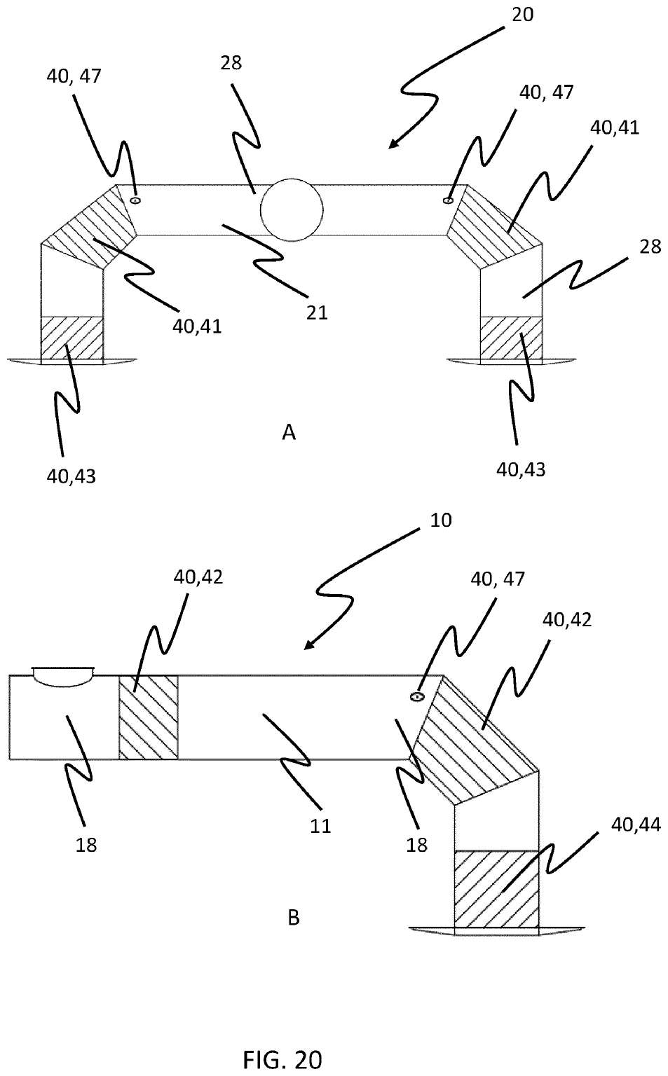

As shown in FIG. 20A,B both horizontal parts 11,21 are configured with one or more external filling valves 47 for filling water into the hollow volumes 18,28 when the main sections 10,20 are floating with the horizontal parts 11,21 arranged below the vertical parts 12,22.

In the particular configuration shown in FIG. 4, both the transverse main section 20 (FIG. 4A) and the aft main section 10 (FIG. 4B) also include buoyancy tanks 41,42, which are permanently closed, passive tanks comprising air. The buoyancy tanks 41,42 are arranged higher up than the ballast tanks 43,44, and further towards the support structure's horizontal center. In FIG. 4A the transition cones 23 are shown as exemplary locations of the buoyancy tanks 41. In FIG. 4B, buoyancy tanks 42 are located both within the transition cone 13 and within the horizontal pipe 11 close to the connecting flange 15. In an alternative configuration the buoyancy tanks 41,42 may be (as for the ballast tanks 43,44) liquid fillable/drainable volumes. If the buoyancy tanks 41,42 are configured as liquid fillable/drainable volumes, they comprise opening valves suitable for filling and draining the buoyancy tanks. The opening valves on the buoyancy tanks 41,42 may allow for flow of fluid between the buoyancy tanks 41,42 and hollow volumes 18,28 and/or the external environment of the support structure 1.

As shown in FIG. 21A,B the buoyancy tanks 41,42 may have through openings 48,49 suitable for allowing fluid such as water or air to pass.

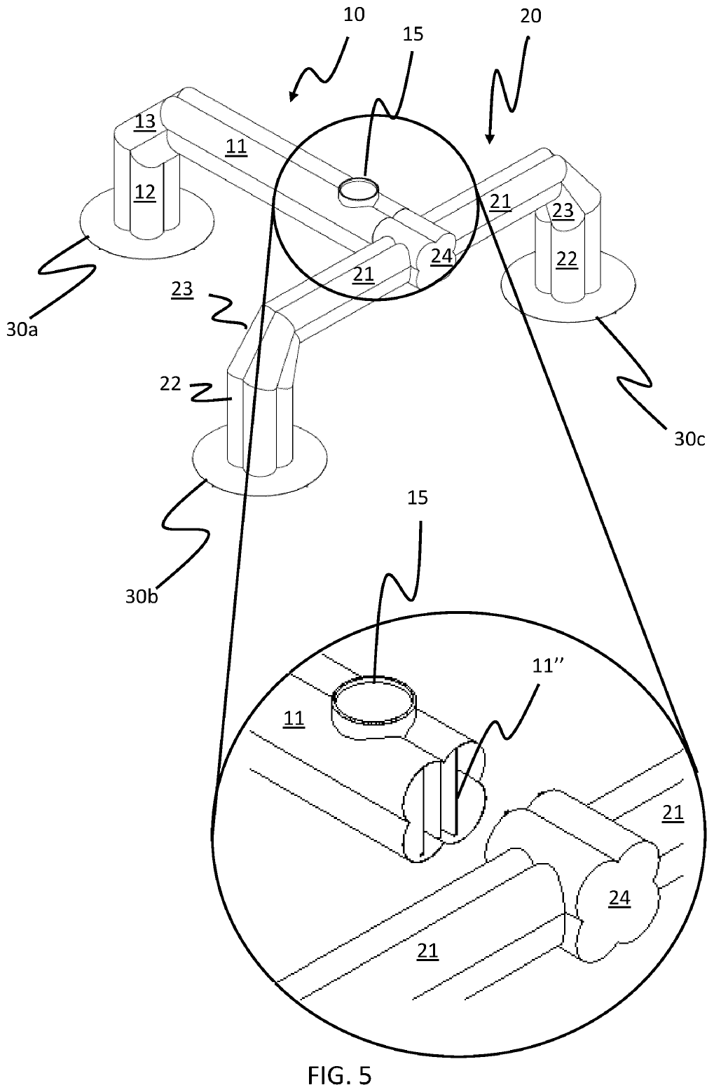

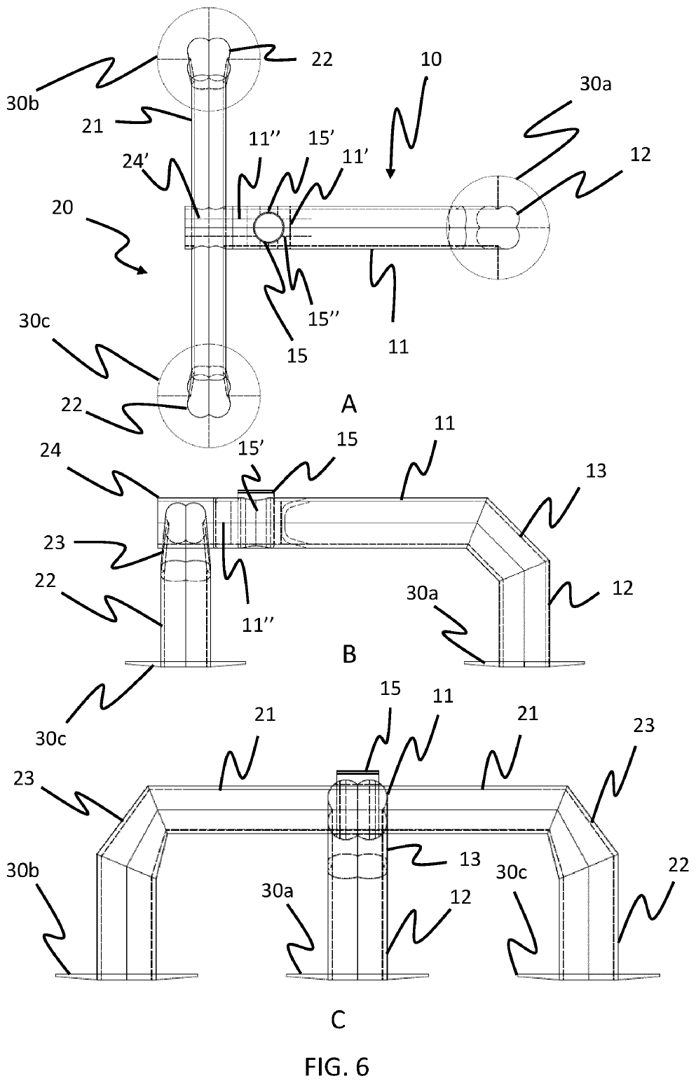

The specific purpose of the buoyancy tanks 41,42 will be explained in more detail below. FIG. 5 shows a second embodiment of the support structure 1. Instead of single, large diameter pipes 11-13,21-23 to ensure sufficient structural strength, each corresponding part 11-13,21-23 of the support structure 1 is composed of a plurality of parallel running pipes or pipe sections. FIG. 6 shows cross-sectional areas of the second embodiment in a top view (FIG. 6A), a side view seen along the transverse direction (FIG. 6B) and another side view seen along the longitudinal direction (FIG. 6C). As seen in these cross-sectional drawings and in the detailed drawing in FIG. 5, reinforcement plates 11′,11″,15′,15″,24′ are connected within the hollow volumes of the pipe sections in the same or similar way as within the pipes of the first embodiment.

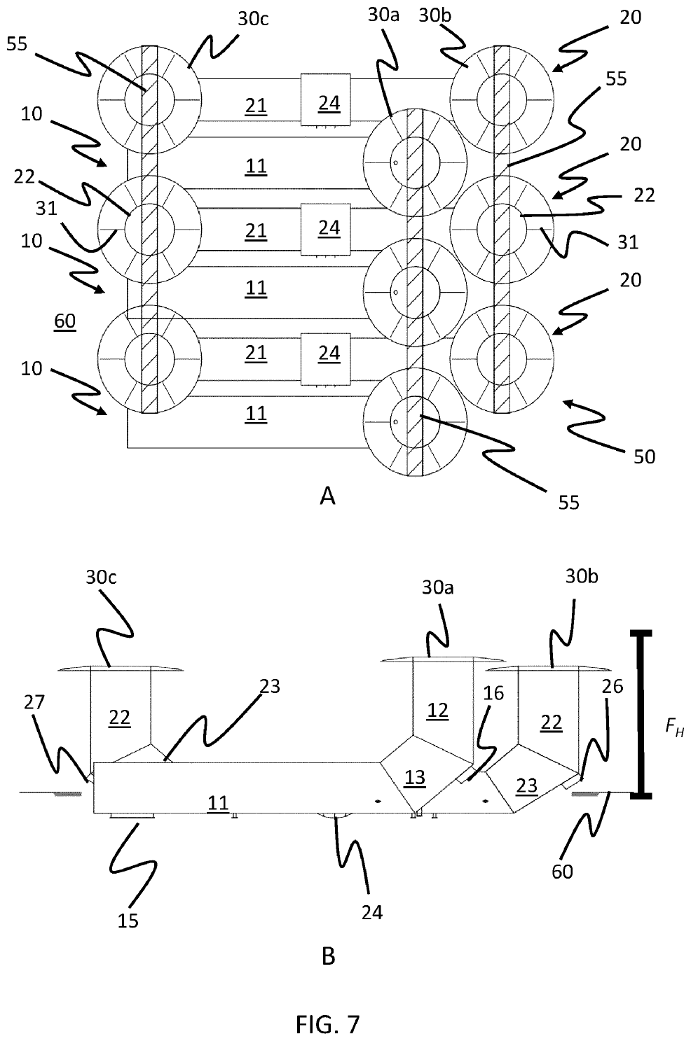

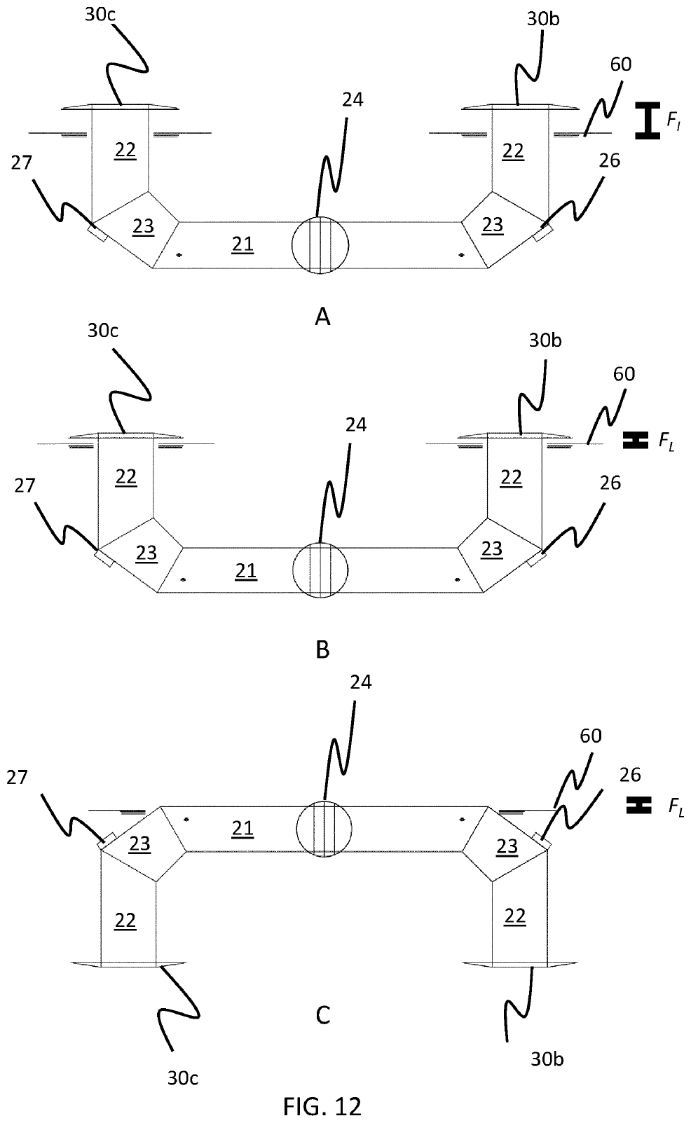

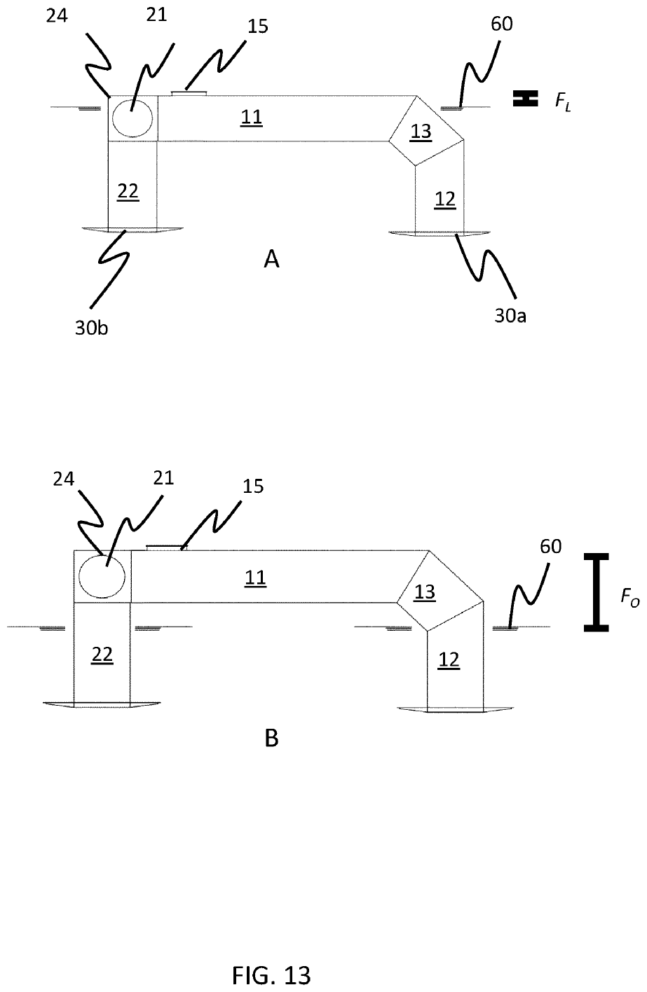

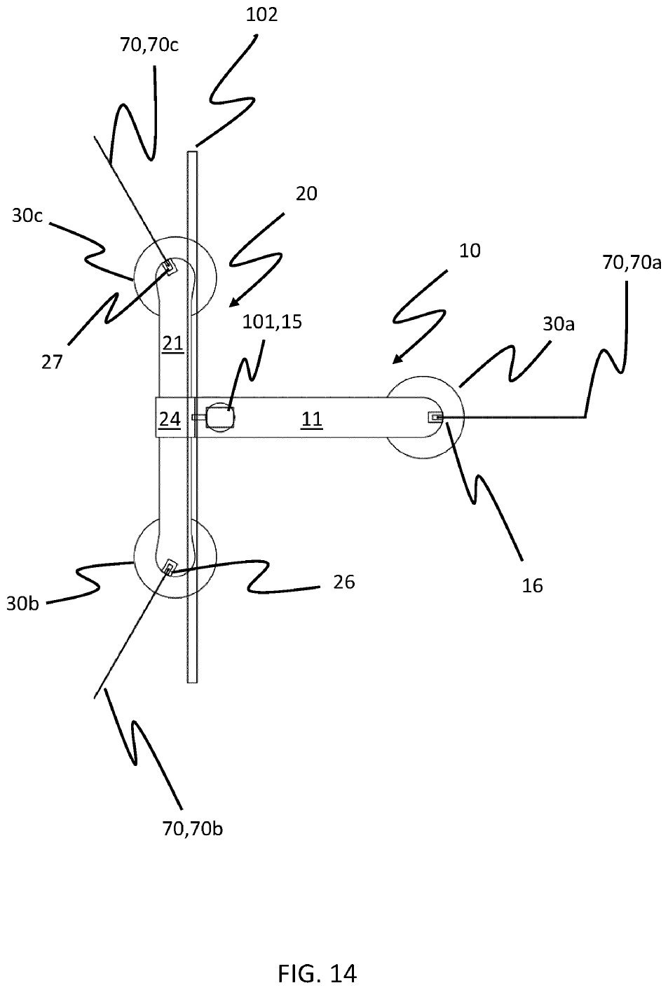

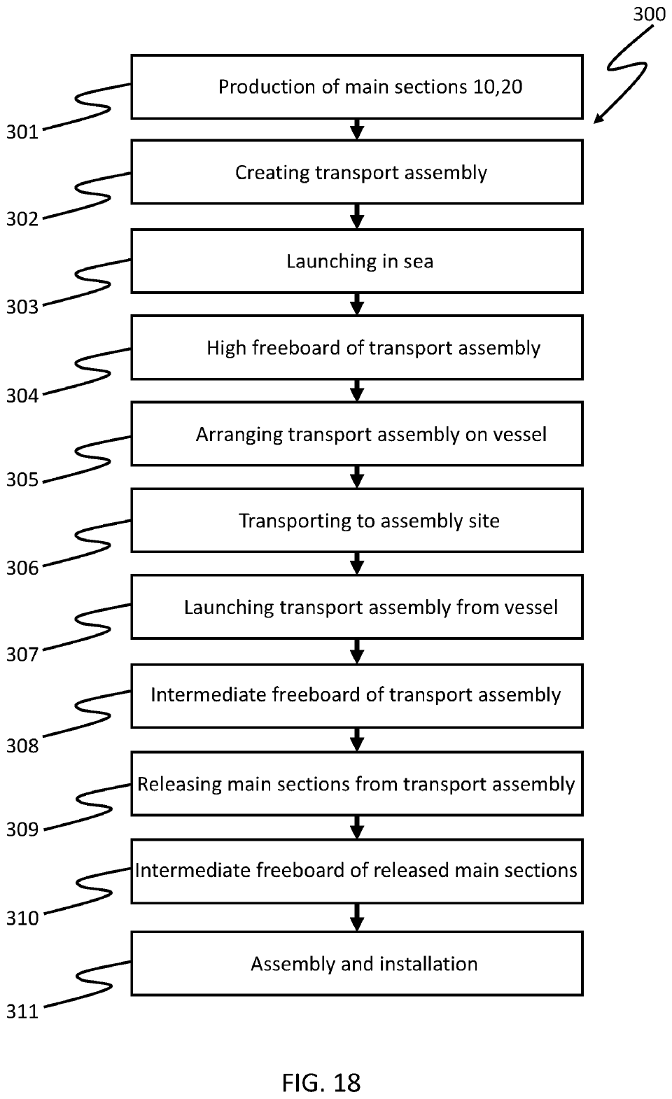

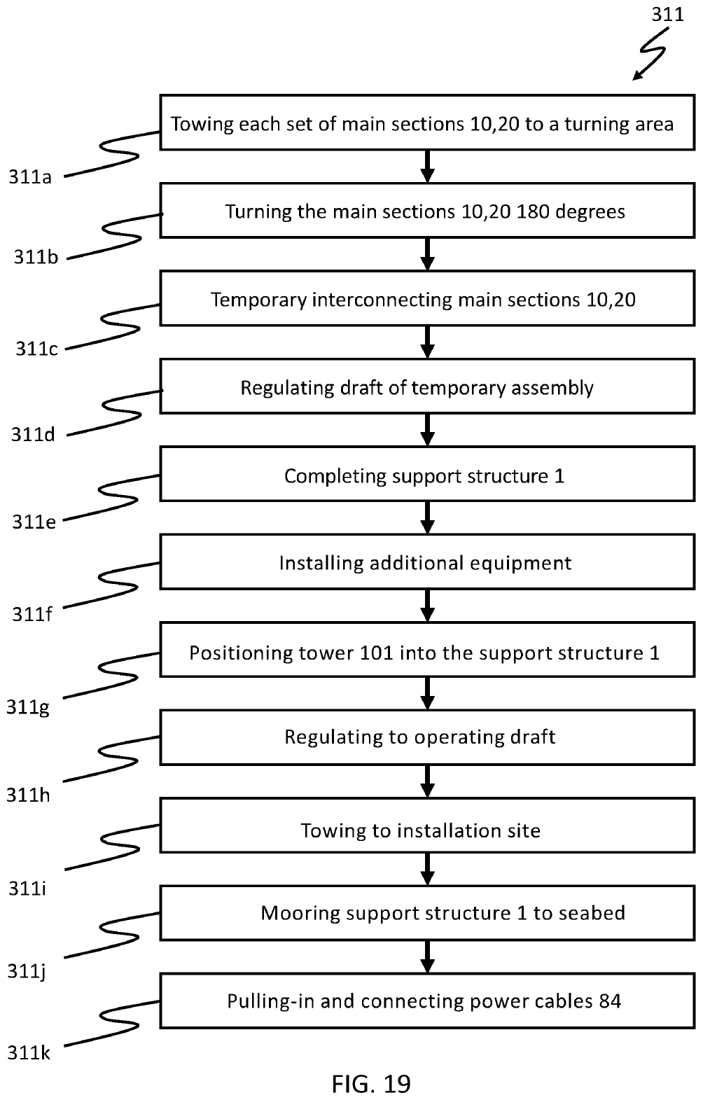

The complete method for production, transport, assembly and installation is described below with reference to FIGS. 7-21, and with particular reference to the flowchart 300 of FIG. 18 which shows the steps for production, transport, launching and preparing for assembly and the flowchart 310 of FIG. 19 which shows the steps for assembling the support structure 1, towing the support structure 1 to the operation site and installing the windmill assembly 100.

301. Production of main sections 10,20 constituting parts for the support structure 1.

At least one, preferably several, of the two main sections 10, 20, i.e. the aft/longitudinal main section 10 and the transverse main section 20, will be completed at a shipyard or equivalent facility. To be able to optimize the space, and thereby the transport efficiency, from the shipyard to the assembly site, the two main sections 10,20 are at this initial stage not joined together via the coupling structure 24 to form the desired support structure 1. See also FIG. 3.

302. Locking main sections 10,20 side by side using locking structure 50

To be able to carry as many building blocks for the support structure 1 as possible in one shipping, the main sections 10,20 produced in the shipyard will be placed upside-down and locked together with a removable (non-permanent) locking structure 55 to form a transport assembly 50. The locking structure 55 may for example be a plurality of metal plates/rods extending across the main sections 10,20 as illustrated in FIG. 7A. Alternatively, or in addition, the locking structure 55 may be a plurality of cables or lines. In FIG. 7A an exemplary transport assembly 50 of three aft main sections 10 and three transverse main sections 20 are shown arranged in alternate positions. FIG. 7B shows the transport assembly 50 seen from the side; along a direction perpendicular to the horizontal pipes 11,21.

Relevant sizes of the transport assembly 50 may however vary dependent of the available deck space of the transport vessel 20. Examples are 2 to 6 sets, where a set consists of one aft main section 10 and one transverse main section 20.

303. Launching transport assembly 50 upside down in sea from shipyard.

Due to the locking of the main sections 10,20 with the non-permanent locking structure 55, the complete transport assembly 50 may easily be launched into sea in the up-side-down position, either from a dry deck/quay or similar, or from a launching barge.

Alternatively, the main sections 10,20 may be bundled together to form the transport assembly 50 after having been launched.

304. Regulating draft of transport assembly 50 to a predetermined high freeboard F_{H}

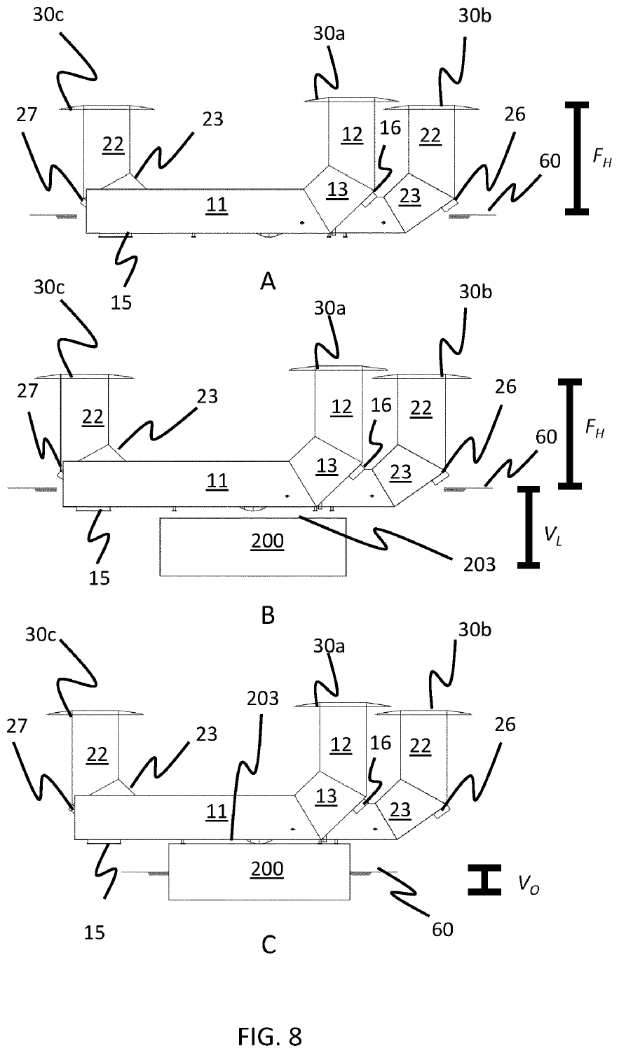

The transport assembly 50 is launched in sea with no ballast in the draft regulator system 40 and the transport assembly 50 is therefore floating at a predetermined, shallow draft/high freeboard F_{H} (see FIG. 7B and FIG. 8A).

When the draft regulator system 40 does not hold any ballast, the shallow draft achieved may also be called the maximum freeboard F_{M}.

Alternatively, if necessary, after the launching of the transport assembly 50 in sea, the buoyancy of the transport assembly 50 may be regulated in order to ensure that the transport assembly 50 is floating at a predetermined, shallow draft/high freeboard F_{H} (see FIG. 7B and FIG. 8A). The buoyancy can be regulated by filling/removing water to/from a draft regulator system 40 integrated into, and/or coupled to, the main sections 10,20.

A preferred example of such a draft regulator system 40 may be a system within hollow volumes 18,28 of the aft main section 10 and the transverse main section 20, comprising ballast tanks 43,44. Furthermore the draft regulator system may comprise buoyancy tanks 41,42 as described above in connection with FIG. 4 and

FIG. 20. The ballast tanks 43,44 are used both to create a stable behaviour of the support structure 1 during operation as well as ensuring successful transport and assembly. Hence, the hollow volumes 18,28 are suitable for containing ballast fluid and can be used for regulating the freeboard between high freeboard (F_{H}), intermediate freeboard (F_{I}) and low freeboard (F_{L}), ensuring successful transport and assembly. The buoyancy tanks 41,42 are primarily used for ensuring successful assembly as explained in further details below.

305. Arranging transport assembly 50 on deck 203 of a semi-submersible heavy lift vessel/transport vessel 200

When in shallow draft position, the transport assembly 50 may easily be towed in position on a semi-submersed heavy lift vessel 200. The heavy lift vessel 200 is first ballasted until a vessel loading draft V_{L} is achieved in which a vessel deck 203 is located deeper than the shallow draft of the transport assembly 50, for example 5 meters. A dedicated vessel such as a tugboat (not shown) may then tow the transport assembly 50 to a position directly above the vessel deck 203 (see FIG. 8B). When in position, the vessel 200 can be de-ballasted until reaching a vessel operational draft Vo in which the vessel deck 203 is positioned above the sea surface 60 and the transport assembly 50 is supported on the vessel deck 203.

The load-on and sea-fastening will not require any assistance from e.g. floating cranes or other high cost equipment and can be completed efficiently at a minimum of time.

306. Transporting transport assembly 50 from the shipyard to an assembly site.

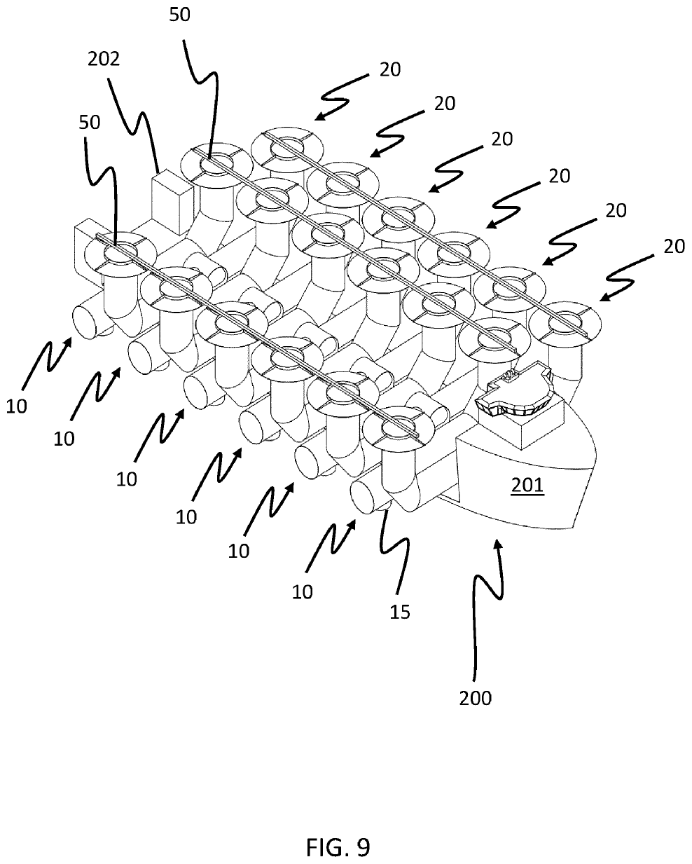

The transport with a semi-submersible heavy lifter vessel/transport vessel 200 can effectively be made over long distance transports, for example between China and Norway. For shorter distance transports submergible barges towed by tugs may be used. FIG. 9 shows an example where three sets of main sections are arranged on the vessel deck 203.

307. Launching transport assembly 50 upside down in water from vessel 200

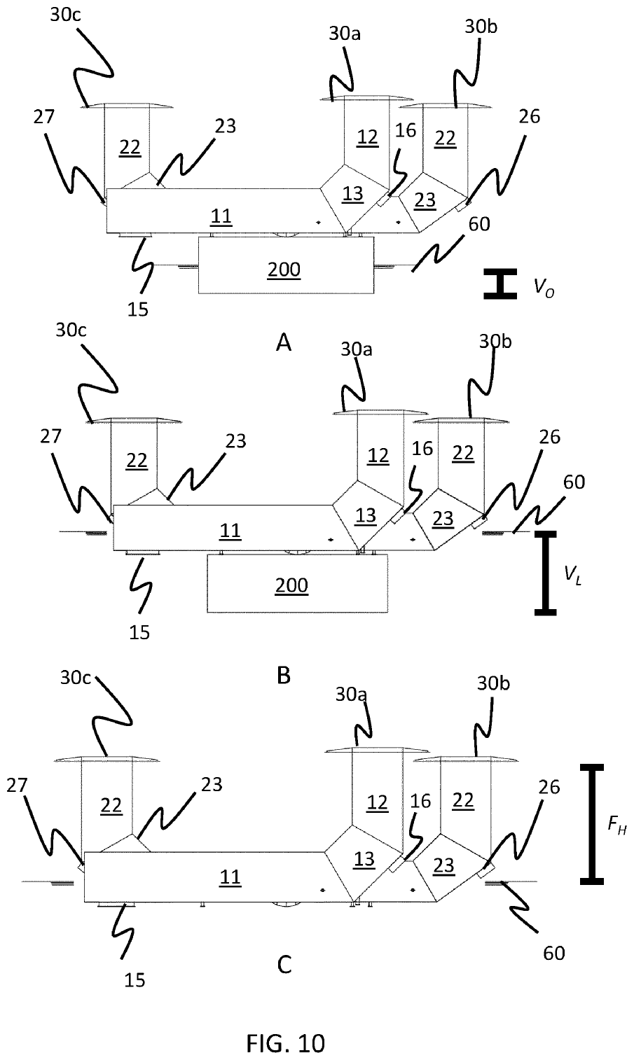

With reference to FIG. 10A-C, the unloading procedure will be the same as for arranging the transport assembly 50 onto the heavy lift vessel 200, i.e., positioning the vessel 200 on or near the assembly site (for example at a harbor within a sheltered bay) (FIG. 10A), removing any sea-fastening equipment fastening the transport assembly 50 to the vessel 200, ensuring that the transport assembly 50 is prepared for high freeboard F_{H} when submersed in water, ballasting the vessel 200 until the deeper loading draft V_{L} is reached and the transport assembly 50 is floating, or near floating (FIG. 10B), and towing the transport assembly 50 away from the deck 203 of the vessel 200 to a quayside or to a mooring location (and/or moving the vessel 200 away from the transport assembly 50) (FIG. 10C). Such a load-off operation has the advantage that it does not require assistance from any high cost equipment and can be completed very cost effective and in a short time.

308. Regulating draft of transport assembly 50 to a predetermined intermediate freeboard F_{I}.

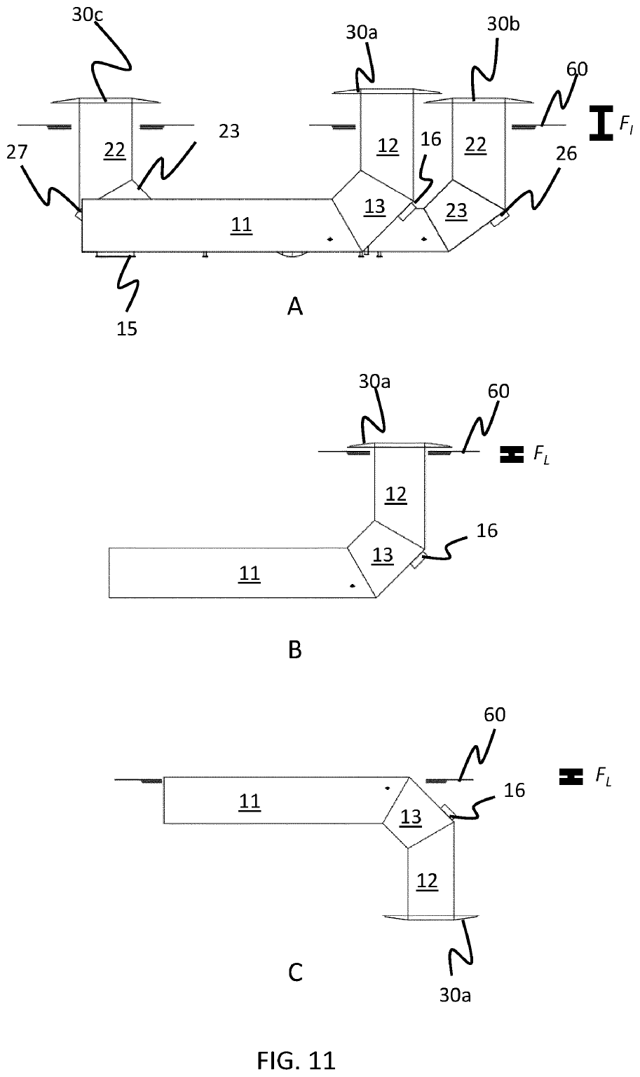

When the transport assembly 50 is safely secured, the draft/buoyancy is regulated until the transport assembly 50 is floating at a draft showing increased stability. A reasonable intermediate freeboard F_{I} at this stage may be about 3 to 5 meters of a typical height of the main sections. See FIG. 11A.

As described in step 304, the draft/buoyancy of the transport assembly 50 can be regulated by filling/removing water to/from the draft regulator system 40 integrated into, and/or coupled to, the main sections 10,20.

309. Removing locking structure 55 to release each main section 10,20 one by one from the transport assembly 50.

When floating at the intermediate freeboard F_{I} where the transport assembly 50, as well as all individual main sections 10,20 are stable in sea, the main sections 10,20 may be released, preferably one by one, from the locking structure 55, which in FIG. 7A is shown located on the top of the transport assembly 50.

When each individual main section 10,20 is floating at the intermediate freeboard (F_{I}), the individual sections 10,20 will float stably in the water with the horizontal parts 11,21 oriented below the vertical parts 12,22

310. Regulating draft of main sections 10,20 to a predetermined intermediate freeboard F_{I}

After the main sections 10,20 are released, the draft of the individual main sections 10,20 are regulated to a low intermediate freeboard F_{IL}, which is lower than that of the intermediate freeboard F_{I} of the transport assembly 50. The lower intermediate freeboard F_{IL}, of the individual main sections 10,20 is reached by filling more water in the draft regulator system 40. The lower intermediate freeboard F_{IL}, allows for disconnecting the main sections 10,20 from the locking arrangement 55 and to ensure stability in the water. The lower intermediate freeboard F_{IL}, means a freeboard low enough to enable disconnection from the locking arrangement 55.

311. Assembling the support structure 1 and installing the floating windmill facility 100

311a. Towing each set of main sections 10,20 to a dedicated turning area.

In order to start the assembling of the support structure 1, the two main sections 10,20 constituting the support structure set are towed to a location for turning that exceeds a predetermined safety distance from the other main sections 10,20 of the transport assembly 50 launched from the vessel 200.

311b. Turning the main sections 10,20 180 degrees around a horizontal axis of rotation.

Prior to interconnecting the main sections 10,20, they must be turned from their upside-down orientation to the correct orientation in a stable and secure way. After the main sections 10,20 are towed to the location for turning, more water is filled into the hollow volumes 18,28 via the external filling valves 47 to further lower each main section 10,20 to a low freeboard F_{L},

Adjusting to a low freeboard F_{L} is done to initiate the turning of the main sections 10,20. Lowering the main sections is done by operating the draft regulator system 40.

The main function of the buoyancy tanks 41,42 is first to provide instability when a main section 10,20 is floating upside down at a low freeboard F_{L}, that is sufficient for initiating the turning of a main section 10,20 from the upside down position to the correct operational position where the horizontal parts 11,21 are oriented above the vertical parts 12,22. When floating at a low freeboard F_{L}, the main section 10,20 will in its upside-down orientation be unstable and rotate until it reaches a stable position. The buoyancy tanks 41,42 (normally two or more for each main section 10,20) are designed with sufficient volume to give a second main function that is to give a stable floating position where the main sections 10,20 are floating with the horizontal parts 11,21 oriented above the vertical parts 12,22 and with the upper part of the horizontal parts (11,21) floating above the sea surface. The operation is repeated for the next main section 10,20. In one exemplary method the rotation may be achieved by exposing each main section 10,20 for an external force, for example from a tug boat.

When the main sections 10,20 are turned to correct orientation and floating stable next to each other, the assembly of the main sections 10,20 into the floating support structure 1 may start.

311c. Temporary interconnecting main sections 10,20 via the coupling structure 24.

The assembly starts by orienting and positioning the aft main section 10 and the transverse main section 20 relative to each other to prepare for interconnection, for example by aid of a tug boat. The initial connection is made with the sections 10,20 floating at the draft obtained after rotation to the correct orientation. If necessary, the freeboard of the main sections 10,20 may be adjusted by use of the draft regulator system 40 to vertically align the coupling structure 24 and the end of the horizontal pipe 11.

At the final stage, preinstalled guide plates at the top of the main sections 10,20 are guiding the two sections 10,20 in correct position. The plates are then welded together to temporarily secure the sections 10,20 in order for the next phase to commence.

311d. Regulating draft of the temporary assembly.

The next step is to pump out water from the hollow volumes 18,28 and ballast tanks 40,43,44 (and, if needed, also the buoyancy tanks 40,41,42) until the two horizontal pipes 11,21 are well above the water surface 60.

311e. Completing support structure 1.

When the pipes 11,21 are in a dry environment (above the water surface 60), the final welding for assembling the two main sections 10,20 into the support structure 1 can be completed.

311f. Installing additional equipment.

After the final welding, the remaining equipment such as supports 16,26,27 for mooring lines 70,70a-c and winch(es) 80 may be mounted onto the respective main sections 10,20. Any pre-installment of mooring line sections 70,70a-c may also be connected at this stage.

To avoid handling of heavy mooring line equipment during mooring at the installation site, the mooring lines 70,70a-c may be split in two segments where the upper segment can be preinstalled in the assembly site/harbor.

311g. Positioning base end of windmill tower 101 into the support structure 1.

After the installment of the additional equipment, the lower base end of the windmill tower 101, with or without the accompanying windmill nacelle 102 and windmill blades 103, is guided and fastened to the connecting flange 15 of the support structure 1. This operation may be performed by a suitable crane located on a quay or on an installation vessel.

311h. Regulating draft to operating draft

When all necessary equipment is in place the support structure 1 will be ballasted to a towing draft, for example to the planned operating draft. Ballast tanks 43,44 will then be closed. Adjustments of the buoyancy by filling/emptying the buoyancy tanks 41,42 may also be performed at this stage.

311i. Towing support structure 1 with equipment to installation site.

The complete support structure 1 with equipment is towed out to the installation/operation site at the operating draft.

311j. Mooring support structure 1 to seabed.

As mentioned above (step 311f) part of the mooring system 16,26,27 may be preinstalled before the support structure 1 arrives at the installation site. This may include segments of the mooring lines 70a-c attached to the supports 16,26,27.

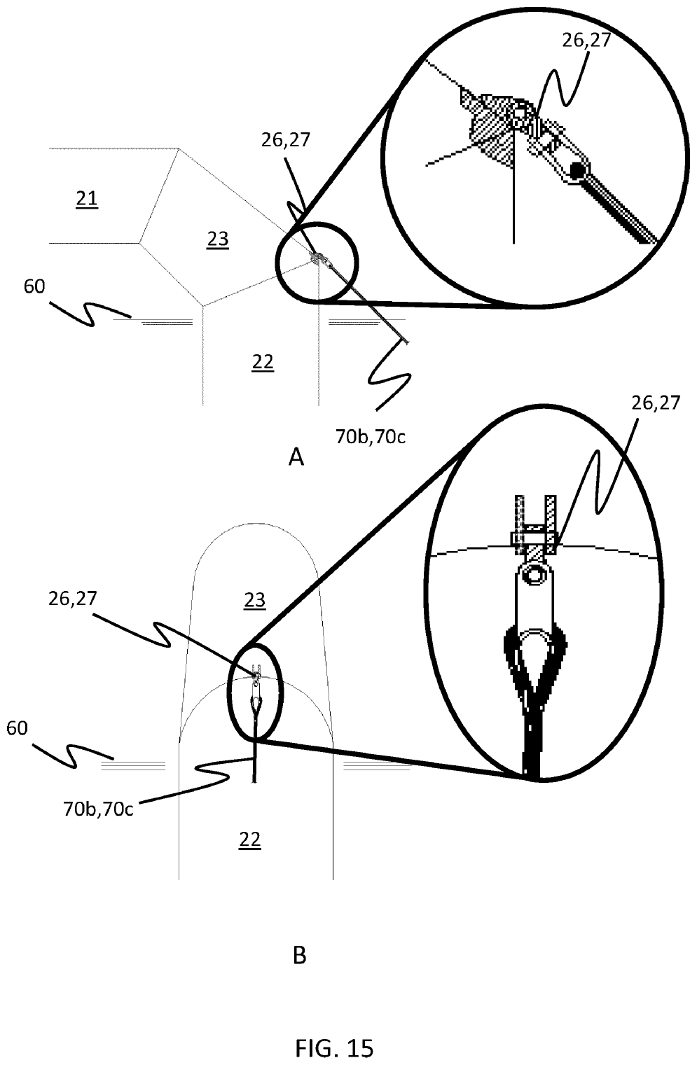

Connections of mooring lines 70,70a-c at the installation site start with connecting the mooring lines 70b,c to the transverse main section 20. The transverse mooring lines 70b,c can be connected one by one after the support structure 1 has been towed to a position where these mooring lines 70b,c will have no tension. FIG. 15A and FIG. 15B show examples of static fastening devices 26,27 where the end of each mooring line 70b,c is attached statically in the sense that the fastening device 26,27 itself only serves to hold the respective mooring line 70b,c and to allow necessary pivot movements.

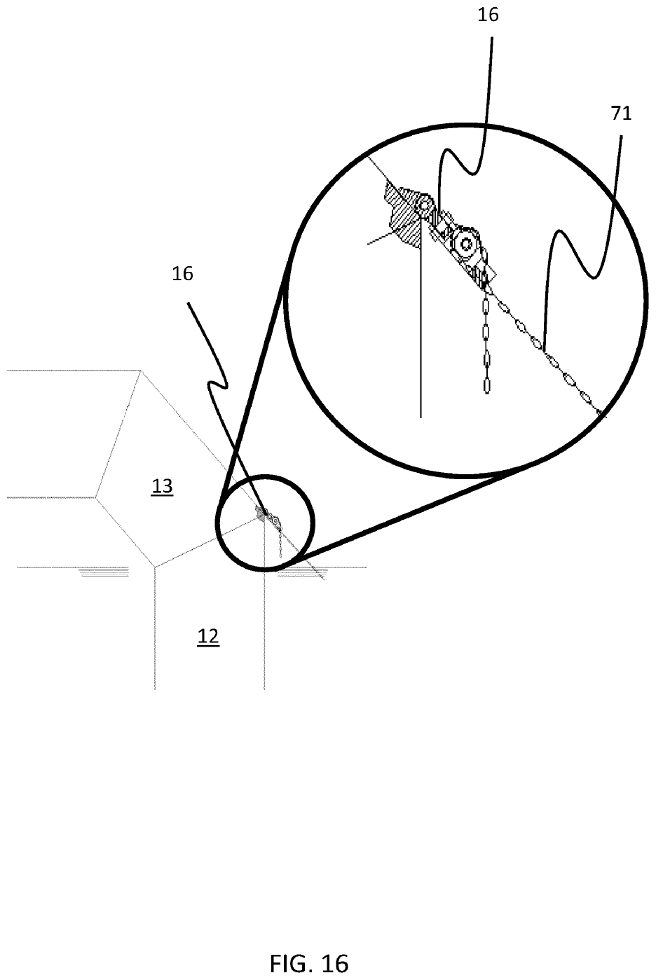

The final stage of the mooring sequence is to connect the end of the last (aft) mooring line(s) 70a to a dynamic fixing device 16 on the aft main section 10. The term ‘dynamic’ means in this particular embodiment that the fixing device 16 allows tensioning and locking of the mooring line 70a after connection. The tensioning may be made/aided by one of the installation tugs used for anchor handling. After the desired tensioning is completed, the support structure 1 is ready for operation, optionally after additional/emptying of the ballast tanks 43,44 and/or the buoyancy tanks 41,42 to ensure correct operational draft. Advantageously, a length of the last mooring line 70a attached to the dynamic fixing device 16 is a chain 71 or the like in order to inter alia enable use of known tensioning devices as exemplified in FIG. 16.

311k. Pulling-in and connecting power cables.

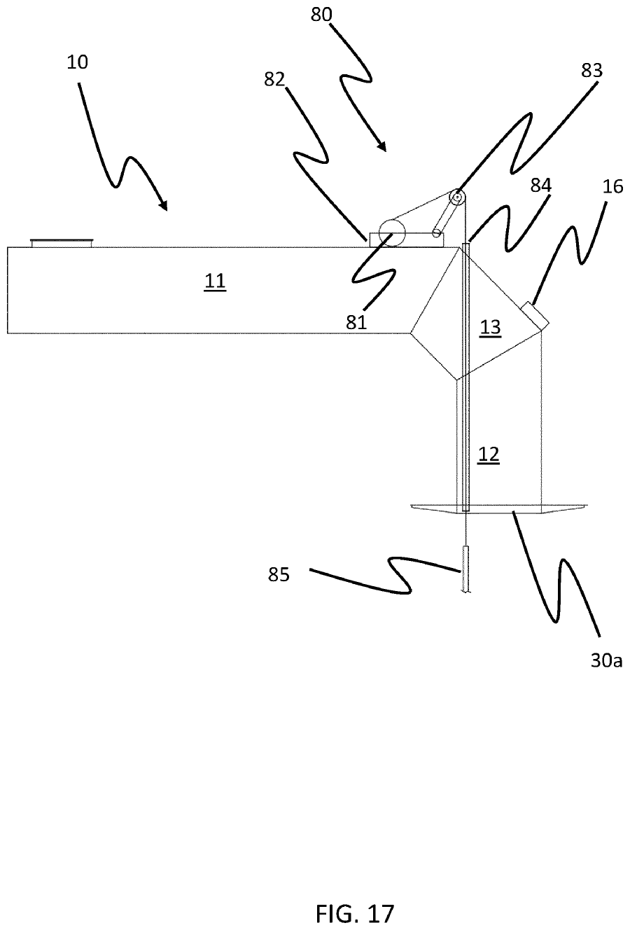

Next phase is to pull-in and connect one or more power cables 84 to the support structure 1 using a winch system 80. A pull-in winch 81 is installed on a winch support 81, which again is fastened (releasably or permanent) to support structure 1, in order to facilitate the power cable 84 pull-in. In FIG. 17, an exemplary configuration of the winch system 80 is shown fastened to the horizontal pipe 11 of the aft main section 10. The pull-in of the power cable 84 by the pull-in winch 81 is performed via a dedicated pull-in line 83 attached to the end of the power cable 83. The pull-in line 83 and the power cable 85 are in FIG. 17 shown to be guided through a guide pipe 84 running through the transition cone 13 and the vertical pipe 12. However, such pull-in operation may also, or alternatively, be performed outside the support structure 1.

With the cable 84 locked in position on the support structure 1, it will be connected to a cable arrangement on board. The pull-in winch 81 may be kept on board. Alternatively, it may be disconnected and stored more safely on land.

If more heavy service or modifications of windmill facility 100 are required, the windmill facility 100 may be towed to a suitable yard/harbor for service/upgrade, etc. Disconnection and reconnection of both the mooring system 70 and the power cable 84 does not involve any complex operations.

In the preferred embodiment, no ballast operations are required during operation at the installation site.

In the preceding description, various aspects of the system and the method according to the invention have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiments, as well as other embodiments of the system and the method, which are apparent to persons skilled in the art to which the disclosed subject matter pertains, are deemed to lie within the scope of the present invention.

### REFERENCE NUMERALS

1 Support structure for floating windmill
10 Aft main section/Longitudinal main section/
11 Horizontal pipe in aft main section 10/aft horizontal part
11′ Transverse reinforcement plate in horizontal pipe 11
11″ Longitudinal reinforcement plate in horizontal pipe 11
12 Vertical pipe in aft main section 10/aft vertical part
13 Transition cone between horizontal pipe 11 and vertical pipe 12 in aft main section 10/aft angled part
15 Connecting flange for windmill tower 101
15′ Transverse reinforcement plate on connecting flange 15
15″ Longitudinal reinforcement plate on connecting flange 15
16 Dynamic fastening device for mooring line connection on aft main section
18 Hollow volume of the aft main section 10
20 Transverse main section
21 Horizontal pipe in transverse main section 20/transverse horizontal part
22 Vertical pipe in transverse main section 20/transverse vertical part
23 Transition cone between horizontal pipe 21 and vertical pipe 22 in transverse main section 20/transverse angled part
24 Coupling structure connecting aft main section 10 and transverse main section 20
24′ Longitudinal reinforcement plate in coupling structure 24.
25 Joint (between aft main section 10 and transverse main section 20)
26 First static fastening device for mooring line connection on transverse main section 20
27 Second static fastening device for mooring line connection on transverse main section 20
28 Hollow volume of the transverse main section 20
30 Damping structure
30a Horizontal damping plate on aft main section 10
30b First horizontal damping plate on transverse main section 20
30c Second horizontal damping plate on transverse main section 20
40 Draft regulator system
41 First buoyancy tank, buoyancy tank on transverse main section 20
42 Second buoyancy tank, buoyancy tank on aft main section 10
43 First ballast tank, ballast tank on transverse main section 20
44 Second ballast tank, ballast tank on aft main section 10
45 Opening valve for ballast tank 43, 44
46 Internal filling valve for ballast tank 43,44
47 External filling valve on the horizontal parts 11, 21
48 Through opening in the first buoyancy tank on the transverse main section 20
49 Through opening in the second buoyancy tank 42 on the aft main section 10
50 Transport assembly
55 Removable (non-permanent) locking structure for locking sections together during transport
60 Sea surface
70 Mooring assembly
70a Aft mooring line connection on aft main section 10
70b First transverse mooring line connection on transverse main section 20
70c Second transverse mooring line connection on transverse main section 20
71 Chain
80 Winch system for pull-in and connection of power cable
81 Pull-in winch
82 Winch base for supporting pull-in winch
83 Pull-in line for power cable
84 Guide pipe for power cable
85 Power cable
100 Windmill facility
101 Windmill tower
102 Windmill nacelle
103 Windmill blades
200 Heavy lift vessel/semi-submersible transport vessel
201 Bow section of heavy lift/transport vessel 200
202 Aft section of heavy lift vessel 200
203 Vessel deck of heavy lift vessel 200
300 Flowchart
301 Production of main sections 10,20 for support structure 1
302 Locking main sections 10,20 side by side using locking structure 55
303 Launching transport assembly 50 upside down in water from shipyard
304 Regulating draft of transport assembly 50 to a predetermined high freeboard F_{H}
305 Arranging transport assembly 50 on deck of a heavy lift vessel 200
306 Transporting main sections from shipyard to an assembly site
307 Launching transport assembly 50 upside down in water from vessel 200
308 Regulating draft of transport assembly 50 to a predetermined intermediate freeboard F_{I}
309 Removing locking structure 50 to release each main section 10,20 one by one.
310 Regulating draft of released main sections 10,20 to a predetermined intermediate freeboard F_{I}
311 Assembling the support structure 1 and installing the windmill assembly 100 with the support structure 1 on an operation site.
311a Towing each main section 10,20 to a location that exceeds a predetermined safety distance from other main sections 10,20 launched from the vessel 200
311b Turning main section 10,20 108 degrees around a horizontal axis of rotation
311c Pre-connecting aft main section 10 and transverse main section 20 by welding together guide plates preinstalled on the main sections.
311d Regulating draft of the pre-connected main sections 10,20 to a predetermined high freeboard F_{H} in which the horizontal pipes 11,12 of the main sections 10,20 are above the water surface 60.
311e Performing final connection of the aft main section 10 and the transverse main section 20 to the support structure 1 by welding the horizontal pipes 11,12 together via a coupling structure 24.
311f Installing additional equipment such as supports 16,26,27 for mooring lines 70,70a-c and winch(es) 80
311g Positioning a base end of the windmill tower 101 to the connecting flange 15 of the assembled support structure 1.
311h Regulating to operating draft.
311i Transporting the support structure 1, the windmill tower 101, the windmill nacelle 102 and the windmill blades 103 constituting a complete windmill assembly 100 to the operation site.
311j Mooring the support structure 1 to the seabed by connecting the supporting structure 1 to a mooring assembly 70 comprising three mooring lines 70a-c.
311k Installing power cable 84 by use of a pull-in winch 80 arranged on the support structure 1.

1. A floating support structure for supporting a windmill system comprising a windmill tower, a windmill nacelle, and windmill blades, wherein the support structure comprises:
an aft main section (10) comprising:
a horizontal aft part with a first horizontal aft end and a second horizontal aft end,
a vertical aft part with a first vertical aft end at least indirectly connected perpendicular to the first horizontal aft end and a second vertical aft end, wherein the vertical and the horizontal aft parts are oriented in a common vertical aft plane, and
an aft damping structure connected to the second vertical aft end, wherein a horizontal cross sectional area of the aft damping structure is larger than a horizontal cross-sectional area of the second vertical aft end,
a transverse main section (20) comprising:
a horizontal transverse part with a first horizontal transverse end and a second horizontal transverse end,
two vertical transverse parts, each having a first vertical transverse end and a second vertical transverse end, wherein the first vertical transverse ends of the vertical transverse parts are at least indirectly connected perpendicular to the first and second horizontal transverse ends, wherein the two vertical transverse parts and the horizontal transverse part are oriented in a common vertical transverse plane, and
two transverse damping structures connected to the second vertical transverse ends of the respective two vertical transverse parts, wherein a horizontal cross sectional area of each of the transverse damping structures is larger than a horizontal cross sectional area of the second vertical transverse end, and
a connecting flange for connecting a coupling end of the windmill tower distal to the windmill nacelle vertically onto the floating support structure,
wherein the second horizontal aft end of the aft main section is connected to the horizontal transverse part of the transverse main section such that the vertical aft plane is oriented perpendicular to the vertical transverse plane.

2. The floating support structure according to claim 1, wherein the connecting flange is arranged on the horizontal aft part.

3. The floating support structure according claim 2, wherein the connecting flange has a tubular shape with an inside diameter being equal or larger than an outside diameter of the coupling end of the windmill tower.

4. The floating support structure according to claim 2, wherein the horizontal aft part encloses at least one hollow volume adjacent the connecting flange, wherein at least one reinforcement structure is arranged within the at least one hollow volume.

5. The floating support structure according to claim 1, wherein each of the horizontal aft part, the vertical aft part the horizontal transverse part and the vertical transverse parts encloses at least one hollow volume.

6. The floating support structure according to claim 5, wherein at least a ballast section of the at least one hollow volume within the vertical aft parts and the vertical transverse parts is filled with a ballast substance allowing regulation of the draft of the floating support structure when submerged in water.

7. The floating support structure according to claim 1, wherein the second horizontal aft end is connected at a longitudinal mid position, or near a longitudinal mid position, of the horizontal transverse part.

8. The floating support structure according claim 1, wherein the second horizontal aft end of the aft main section is connected to the horizontal transverse part via a coupling structure.

9. The floating support structure according to claim 8, wherein the coupling structure encloses at least one hollow volume, wherein at least one reinforcement structure is arranged within the at least one hollow part.

10. The floating support structure according to claim 1,
wherein the aft main section further comprises:
a bent aft part connecting the second horizontal aft end of the horizontal aft part to the first vertical aft end of the vertical aft part, and
wherein the transverse main section further comprises:
two bent transverse parts connecting the first and second horizontal transverse ends of the horizontal transverse part with the respective first vertical transverse ends of the two vertical transverse parts.

11. The floating support structure according to claim 10, wherein
the bent aft part extends from the horizontal aft part at an aft angle αA relative to the horizontal plane and
the two bent transverse parts each extend from the first horizontal transverse end and the second horizontal transverse end, respectively, at a transverse angle αT relative to the horizontal plane,
wherein the aft angle αA and the transverse angle αT have non-zero values.

12. The floating support structure according to claim 11, wherein the aft angle αA and the transverse angle αT are equal, or near equal.

13. The floating support structure according to claim 10, wherein
the bent aft part is shaped as a frustum having its smallest cross-sectional area connected to the second horizontal aft end, and/or
each of the two bent transverse parts is shaped as frustum having its smallest cross-section area connected to the respective first and second horizontal transverse ends.

14. The floating support structure according to claim 10,
wherein each of the bent aft parts and the two bent transverse parts encloses at least one hollow volume and
wherein at least a buoyancy section of the at least one hollow volume within the bent aft part and the two bent transverse parts is configured to be filled with a buoyancy substance allowing regulation of the buoyancy of the floating support structure when submerged in water.

15. The floating support structure according to claim 1, wherein each of the horizontal aft part, the vertical aft part, the horizontal transverse part and the vertical transverse parts has a tubular shape.

16. The floating support structure according to claim 1, wherein the floating support structure further comprises a mooring assembly comprising:
an aft mooring line connected to the aft main section,
a first transverse mooring line connected to an end part of the transverse main section along the vertical transverse plane, and
a second transverse mooring line connected to the opposite end part of the transverse main section along the vertical transverse plane.

17. A windmill facility comprising:
a floating support structure for supporting a windmill system comprising a windmill tower, a windmill nacelle, and windmill blades,
wherein the support structure comprises:
an aft main section comprising:
a horizontal aft part with a first horizontal aft end and a second horizontal aft end,
a vertical aft part with a first vertical aft end at least indirectly connected perpendicular to the first horizontal aft end and a second vertical aft end, wherein the vertical and the horizontal aft parts are oriented in a common vertical aft plane, and
an aft damping structure connected to the second vertical aft end, wherein a horizontal cross sectional area of the aft damping structure is larger than a horizontal cross-sectional area of the second vertical aft end,
a transverse main section comprising:
a horizontal transverse part with a first horizontal transverse end and a second horizontal transverse end,
two vertical transverse parts, each having a first vertical transverse end and a second vertical transverse end, wherein the first vertical transverse ends of the vertical transverse parts are at least indirectly connected perpendicular to the first and second horizontal transverse ends, wherein the two vertical transverse parts and the horizontal transverse part are oriented in a common vertical transverse plane, and
two transverse damping structures connected to the second vertical transverse ends of the respective two vertical transverse parts, wherein a horizontal cross sectional area of each of the transverse damping structures is larger than a horizontal cross sectional area of the second vertical transverse end, and
a connecting flange for connecting a coupling end of the windmill tower distal to the windmill nacelle vertically onto the floating support structure,
wherein the second horizontal aft end of the aft main section is connected to the horizontal transverse part of the transverse main section such that the vertical aft plane is oriented perpendicular to the vertical transverse plane,
a windmill tower having a low end fixed to the connecting flange,
a windmill nacelle fixed at a top end of the windmill tower, and
windmill blades rotationally fixed to the windmill nacelle.
